(19) United States
(12) Patent Application Publication
(10) Pub. No.: US 2021/0104078 A1
(43) Pub. Date: Apr. 8, 2021

(54) TEXTURE FILTERING FOR CONSTANT TEXTURE DATA

(71) Applicant: QUALCOMM Incorporated, San Diego, CA (US)

(72) Inventors: Yadong Wang, San Diego, CA (US); Himanshu Govil, Bangalore (IN); Bagus Prasetyo Wibowo, San Diego, CA (US); Raghavendra Nagaraj, San Diego, CA (US); Liang Li, San Diego, CA (US); Elina Kamenetskaya, Belmont, MA (US)

(21) Appl. No.: 16/591,450

(22) Filed: Oct. 2, 2019

(51) Int. Cl. G06T 11/00; G06T 7/40; G06T 7/90; G06T 5/20; G06T 3/40

(52) U.S. Cl. CPC G06T 11/001; G06T 7/40; G06T 3/4007; G06T 5/20; G06T 7/90

(57) ABSTRACT

Methods, systems, and devices for image processing are described. A device may support various filtering models relating to multidimensional graphics. The device may identify a target texel having a texel coordinate in an image, determine a set of neighboring texels based on the texel coordinate of the target texel, determine color values of multiple neighboring texels of the set of neighboring texels, compare the color values of the multiple neighboring texels of the set of neighboring texels, and process the target texel based on the comparing. In processing the target texel, the device may determine that the multiple neighboring texels may have same color values based on the comparing. The device may bypass a filtering operation on the target texel based on the multiple neighboring texels having the same color values. In an example of bypassing the filtering operation, the device may maintain a color value of the target texel.

### FIELD OF TECHNOLOGY

The following relates generally to image processing, and more specifically to texture filtering for texture data.

### BACKGROUND

Some example devices may support image processing methods to perform operations on an image to get an enhanced image or to extract some image information (e.g. pixel information) from the image. Some example devices may support a multi-dimensional graphics application, and more specifically a graphics processing unit (GPU) that may support image processing methods relating to multidimensional graphics. For example, a GPU may support color image processing on an image. In some examples, GPUs may perform color image processing on an image according to a filtering model, but these methods may be inefficient.

### SUMMARY

The described techniques relate to improved methods, systems, devices, and apparatuses for texture filtering according to constant texture data. By way of example, a device may determine to perform a filtering operation on a target texel based on neighboring texels having different color values or bypass the filtering operation on the target texel based on the neighboring texels having same color values. In some examples, the device may perform the determination using a comparator component, or a mux component, or both to avoid unnecessary texture filtering, and be efficient in using graphics processing unit (GPU) resources. For example, the comparator component may evaluate color values for multiple neighboring texels for a given target texel, and if the neighboring texels for the given texel have a same color value (within a range of one another), the mux component may bypass a filter engine in a processing pipeline of a GPU. Otherwise, the filter engine may process the given texel, for example, by a filtering operation. Accordingly, the described methods, systems, devices, and apparatuses provide improved processing efficiency and bandwidth, thereby reducing overhead on GPU resources and enhancing user experience.

A method of image processing is described. The method may include identifying a target texel having a texel coordinate in an image, determining a set of neighboring texels based on the texel coordinate of the target texel, determining color values of multiple neighboring texels of the set of neighboring texels, comparing the color values of the multiple neighboring texels of the set of neighboring texels, and processing the target texel based on the comparing.

An apparatus for image processing is described. The apparatus may include a processor, memory coupled with the processor, and instructions stored in the memory. The instructions may be executable by the processor to cause the apparatus to identify a target texel having a texel coordinate in an image, determine a set of neighboring texels based on the texel coordinate of the target texel, determine color values of multiple neighboring texels of the set of neighboring texels, compare the color values of the multiple neighboring texels of the set of neighboring texels, and process the target texel based on the comparing.

Another apparatus for image processing is described. The apparatus may include means for identifying a target texel having a texel coordinate in an image, determining a set of neighboring texels based on the texel coordinate of the target texel, determining color values of multiple neighboring texels of the set of neighboring texels, comparing the color values of the multiple neighboring texels of the set of neighboring texels, and processing the target texel based on the comparing.

A non-transitory computer-readable medium storing code for image processing is described. The code may include instructions executable by a processor to identify a target texel having a texel coordinate in an image, determine a set of neighboring texels based on the texel coordinate of the target texel, determine color values of multiple neighboring texels of the set of neighboring texels, compare the color values of the multiple neighboring texels of the set of neighboring texels, and process the target texel based on the comparing.

In some examples of the method, apparatuses, and non-transitory computer-readable medium described herein, processing the target texel may include operations, features, means, or instructions for determining that the multiple neighboring texels may have same color values based on the comparing, and bypassing a filtering operation on the target texel based on the multiple neighboring texels having the same color values.

In some examples of the method, apparatuses, and non-transitory computer-readable medium described herein, bypassing the filtering operation on the target texel may include operations, features, means, or instructions for maintaining a color value of the target texel.

Some examples of the method, apparatuses, and non-transitory computer-readable medium described herein may further include operations, features, means, or instructions for bypassing an additional filtering operation on one or more of the multiple neighboring texels of the set of neighboring texels based on bypassing the filtering operation on the target texel.

In some examples of the method, apparatuses, and non-transitory computer-readable medium described herein, processing the target texel may include operations, features, means, or instructions for determining that the multiple neighboring texels may have different color values based on the comparing, and performing a filtering operation on the target texel based on determining that the multiple neighboring texels may have the different color values.

Some examples of the method, apparatuses, and non-transitory computer-readable medium described herein may further include operations, features, means, or instructions for performing an interpolation operation on the multiple neighboring texels of the set of neighboring texels, determining a sum color value of the color values of the multiple neighboring texels of the set of neighboring texels based on the interpolation operation, and determining a weighted color value based on a weighting coefficient, where performing the filtering operation on the target texel includes.

In some examples of the method, apparatuses, and non-transitory computer-readable medium described herein, the interpolation operation includes a bilinear interpolation operation.

In some examples of the method, apparatuses, and non-transitory computer-readable medium described herein, the image includes a multidimensional grid.

Some examples of the method, apparatuses, and non-transitory computer-readable medium described herein may further include operations, features, means, or instructions for performing a first linear interpolation operation in a first direction of the multidimensional grid based on a fractional value of the texel coordinate, performing a second linear interpolation operation in a second direction of the multidimensional grid different from the first direction based on the fractional value of the texel coordinate, and where determining the sum color value of the color values of the multiple neighboring texels of the set of neighboring texels may be based on a product of the first linear interpolation operation and the second linear interpolation operation.

In some examples of the method, apparatuses, and non-transitory computer-readable medium described herein, determining the color values of the multiple neighboring texels of the set of neighboring texels may include operations, features, means, or instructions for determining a color value of each neighboring texel of the set of neighboring texels, where comparing the color values of the multiple neighboring texels of the set of neighboring texels includes comparing each color value of each neighboring texel of the set of neighboring texels to every other value of each neighboring texel of the set of neighboring texels.

In some examples of the method, apparatuses, and non-transitory computer-readable medium described herein, one or more of the multiple neighboring texels of the set of neighboring texels may be positioned directly adjacent to the target texel.

In some examples of the method, apparatuses, and non-transitory computer-readable medium described herein, the multiple neighboring texels of the set of neighboring texels may be in contact with to the target texel.

In some examples of the method, apparatuses, and non-transitory computer-readable medium described herein, the target texel and one or more of the multiple neighboring texels of the set of neighboring texels may be associated with a same target object in the image.

### BRIEF DESCRIPTION OF THE DRAWINGS

FIG. 1 illustrates an example of a system for image processing that supports texture filtering for texture data in accordance with aspects of the present disclosure.

FIG. 2 illustrates an example texture image that supports texture filtering for texture data in accordance with aspects of the present disclosure.

FIG. 3 illustrates an example of a process flow that supports texture filtering for texture data in accordance with aspects of the present disclosure.

FIGS. 4 and 5 show block diagrams of devices that support texture filtering for texture data in accordance with aspects of the present disclosure.

FIG. 6 shows a block diagram of a filtering manager that supports texture filtering for texture data in accordance with aspects of the present disclosure.

FIG. 7 shows a diagram of a system including a device that supports texture filtering for texture data in accordance with aspects of the present disclosure.

FIGS. 8 through 10 show flowcharts illustrating methods that support texture filtering for texture data in accordance with aspects of the present disclosure.

### DETAILED DESCRIPTION

A device may support a multi-dimensional graphics application (e.g., two-dimensional (2D), three-dimensional (3D)), and more specifically a graphics processing unit (GPU) that may support texture sampling relating to multi-dimensional graphics. Texture sampling may include operations in a graphics pipeline where data may be read from an input texture image provided by the multi-dimensional graphics application. In some devices, texture sampling may support various filtering modes. In an example application, filtering operations may include texture filtering, such as bilinear texture filtering for obtaining constant texture data. Some filtering models may use an input texture image or texture map provided by a graphics application to determine a texture color for a texture pixel (also referred to herein as a “texel”), using texture data of nearby neighboring texels.

By way of example, a filtering model may use colors values of multiple texels based on texel coordinates for a given target texel (e.g., a bilinear filtering model may use color values of four texels). In some examples, the graphics application may determine the texture color (e.g., color value) for the target texel based on an interpolation operation using a weighted average of nearby neighboring texels (e.g., weighted average of color values). The described techniques relate to improved methods, systems, devices, and apparatuses for texture filtering according to constant texture data. By way of example, a device may process a target texel based on color values of neighboring texels of the target texel. For example, the device may determine to perform a filtering operation on the target texel based on neighboring texels having different color values or bypass the filtering operation on the target texel based on the neighboring texels having same color values. In some examples, the device may perform the determination using a comparator component and a mux component to avoid unnecessary texture filtering, which may improve the availability of GPU resources.

In an example, the comparator component may evaluate color values for multiple other texels (e.g., that may be neighboring texels) for a given target texel, and if the neighboring texels for the target texel have a given color value (e.g., a same color value), the mux component may bypass a filter engine in a processing pipeline of a GPU. Otherwise, the filter engine may process the target texel, for example, by a filtering operation. In some examples, the filtering operation may include a bilinear interpolation operation using multiple (e.g., four) neighboring texels of the target texel. In some examples, bypassing the filtering engine may include maintaining a color value of the target texel. By avoiding unnecessary texture filtering, for example, the device may be efficient in using GPU and other resources.

Aspects of the subject matter described herein may be implemented to realize one or more advantages. The described techniques may support improvements in efficiency, reduced overhead on GPU resources, and enhanced user experience, among other advantages. Aspects of the disclosure are initially described in the context of a system and techniques related to graphics processing supportive of various filtering models relating to multidimensional graphics. Aspects of the disclosure are further illustrated by and described with reference to apparatus diagrams, system diagrams, and flowcharts that relate to texture filtering for texture data in a system.

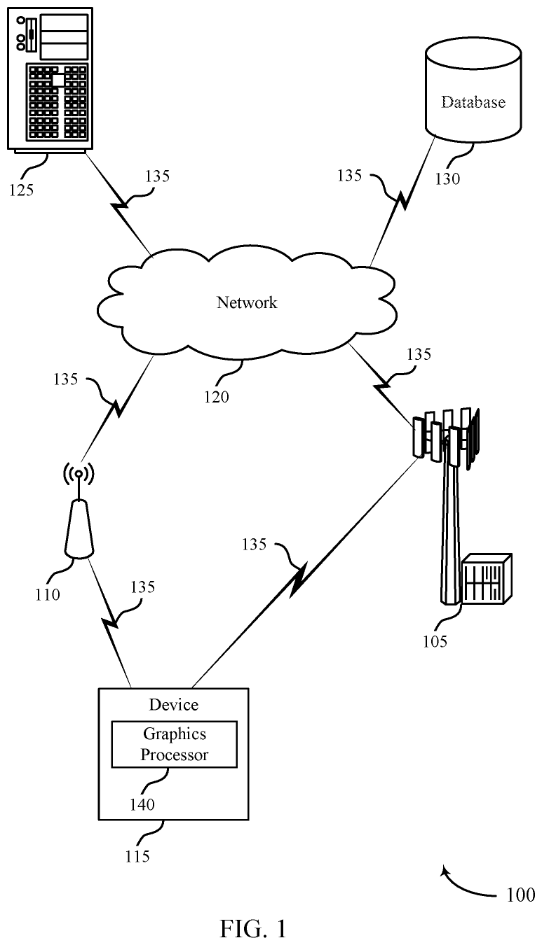

FIG. 1 illustrates an example of a system 100 for image processing that supports texture filtering for texture data in accordance with aspects of the present disclosure. The system 100 may include a base station 105, an access point 110, a device 115, a server 125, and a database 130. The base station 105, the access point 110, the device 115, the server 125, and the database 130 may communicate with each other via network 120 using communications links 135 to support image processing related operations.

The base station 105 may wirelessly communicate with the device 115 via one or more base station antennas. Base station 105 described herein may include or may be referred to by those skilled in the art as a base transceiver station, a radio base station, a radio transceiver, a NodeB, an eNodeB (eNB), a next-generation Node B or giga-nodeB (either of which may be referred to as a gNB), a Home NodeB, a Home eNodeB, or some other suitable terminology. The device 115 described herein may be able to communicate with various types of base stations and network equipment including macro eNBs, small cell eNBs, gNBs, relay base stations, and the like. The access point 110 may be configured to provide wireless communications for the device 115 over a relatively smaller area compared to the base station 105.

In some examples, the device 115 may be stationary and/or mobile. In further examples, the device 115 may include a cellular phone, a smartphone, a personal digital assistant (PDA), a wireless communication device, a handheld device, a tablet computer, a laptop computer, a cordless phone, a display device (e.g., monitors), and/or the like. The device 115 may, additionally or alternatively, include or be referred to by those skilled in the art as a UE, a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some cases, the device 115 may also be able to communicate directly with another device (e.g., using a peer-to-peer (P2P) or device-to-device (D2D) protocol).

In some examples, the device 115 may include a graphics processor 140. The graphics processor 140 may be an electronic circuit configured for computer graphics and image processing, for example, such as in embedded systems, mobile devices, computers, workstations, and gaming consoles. The graphics processor 140 may be, for example, a GPU, an integrated GPU (IGPU), a general purpose GPU (GPGPU), an external GPU (eGPU), and/or the like that may be integrated with the device 115. For example, graphics processor 140 may process a pixel or texel array (e.g., an image, a texture map) representing a scene. The graphics processor 140 may obtain information for an image (e.g., color information) provided by an application (e.g., a multi-dimensional graphics processing application, a gaming application, an image processing application, an image capture application, a video messaging application, a video conferencing application). In some examples, the graphics processor 140 may reconstruct color images (e.g., RGB, YUV or the like) using a filtering method (e.g., linear interpolation) to estimate or calculate any missing color values based on known color values of texels in the image.

The system 100 may provide improvements in graphics processing related operations, and more specifically may support graphics processing inclusive of partial or conditional texture filtering for texture data. For example, device 115 may support processing a target texel in an image, and more specifically, processing the target texel with or without a filtering operation (e.g., bypassing the filtering operation) based on color values of neighboring texels of the target texel. In some examples, device 115 may identify a target texel having a texel coordinate in an image, and determining a set of neighboring texels based on the texel coordinate of the target texel. Additionally or alternatively, device 115 may determine color values of multiple neighboring texels of the set of neighboring texels. Additionally or alternatively, device 115 may compare the color values of the multiple neighboring texels of the set of neighboring texels. Additionally or alternatively, device 115 may process the target texel based on the comparing.

In some examples, as part of processing the target texel, device 115 may determine that the multiple neighboring texels have same color values based on the comparing, and bypassing a filtering operation on the target texel based on the multiple neighboring texels having the same color values. In some examples, as part of processing the target texel, device 115 may determine that the multiple neighboring texels have different color values based on the comparing, and perform a filtering operation on the target texel based on determining that the multiple neighboring texels have the different color values. In some examples, as part of processing the target texel, device 115 may perform an interpolation operation (e.g., a bilinear filtering operation).

The network 120 may provide encryption, access authorization, tracking, Internet Protocol (IP) connectivity, and other access, computation, modification, and/or functions. Examples of network 120 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G) for example), etc. Network 120 may include the Internet.

The server 125 may include any combination of a data server, a cloud server, a server associated with an automation service provider, proxy server, mail server, web server, application server, database server, communications server, home server, mobile server, or any combination thereof. The server 125 may also transmit to the device 115 a variety of information, such as instructions or commands (e.g., configuration information) relevant to supporting graphics processing related operations for texture filtering for texture data. Server 125 may include an application distribution platform. For example, the device 115 may upload or download applications such as a multi-dimensional graphics application. In an example, the device 115 may download a multi-dimensional graphics application from the server 125. In some examples, the graphics application may provide digital synthesis and manipulation of visual content. For example, the device 115 may provide digital synthesis and manipulation of one or more texels in a texture image or texture map.

The database 130 may store data that may include instructions or commands (e.g., configuration information) relevant to supporting graphics processing related operations for texture filtering for texture data. The device 115 may retrieve the stored data from the database 130 via the base station 105 and/or the access point 110. For example, upon receiving a request to provide a configuration file to device 115, server 125 may parse and retrieve the configuration file, from the database 130, based on the information provided in the request (e.g., configuration identifier, operating system type (e.g., Linux, Unix, Mac OS X, Windows) of device 115) and provide the configuration file to the device 115 via the communications links 135. The device 115 may receive the configuration file and apply it to a graphics processing operation. For example, device 115 apply the configuration file to a graphics processor to use in texture filtering for texture data.

The communications links 135 shown in the system 100 may include uplink transmissions from the device 115 to the base station 105, the access point 110, or the server 125, and/or downlink transmissions, from the base station 105, the access point 110, the server 125, and/or the database 130 to the device 115. The downlink transmissions may also be called forward link transmissions while the uplink transmissions may also be called reverse link transmissions. The communications links 135 may transmit bidirectional communications and/or unidirectional communications. The communications links 135 may include one or more connections, including but not limited to, 345 MHz, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to wireless communication systems.

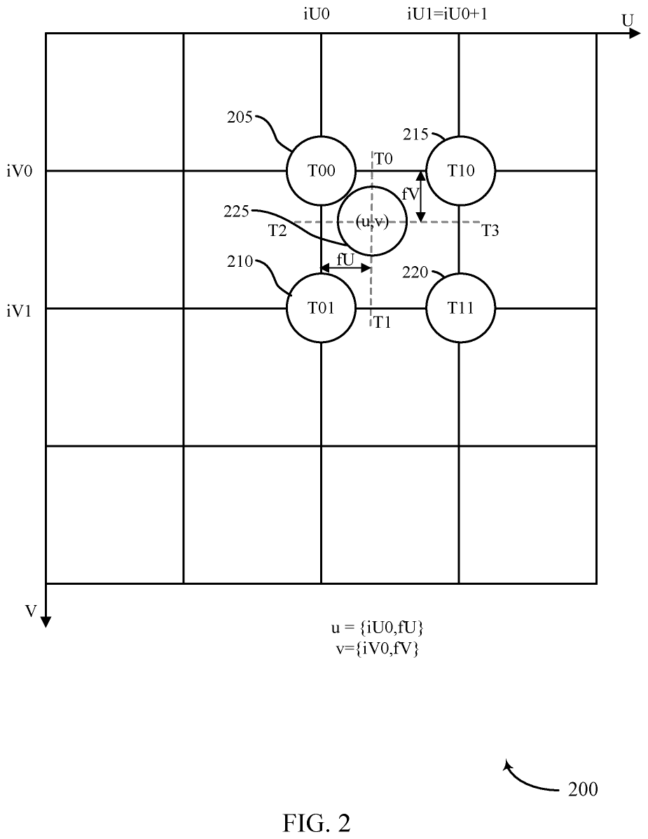

Particular aspects of the subject matter described herein may be implemented to realize one or more advantages. The described methods, systems, devices, and apparatuses provide graphics processing techniques supportive of bypassing a filtering engine in a processing pipeline of a GPU, which may provide improvements in efficiency, reduced overhead on GPU resources, and enhanced user experience (e.g., through improved processing efficiency and bandwidth), among other advantages. Example of texture filtering for texture data is further described in more detail herein with reference to FIG. 2.

FIG. 2 an example texture image 200 that supports texture filtering for texture data in accordance with aspects of the present disclosure. In some examples, texture filtering described herein may be implemented by aspects of system 100. According to example aspects described herein, a device supporting a multi-dimensional graphics application (e.g., 2D, 3D) may include a GPU that may support texture sampling relating to multi-dimensional graphics. For example, the GPU may include texture sampling in a graphics pipeline where data is read from an input texture image provided by the multi-dimensional graphics application. The device and GPU may be examples of aspects of the device 115 and GPU 140.

An image 200 may be defined by a multi-dimensional function F(u,v), where u and v are spatial coordinates, and the amplitude F at any pair of coordinates (u,v) may be an intensity of that image at that point. With reference to FIG. 1, the device 115 may identify a target texel 225 having a texel coordinate (u,v) in the image 200 (e.g., a texture coordinate in an input texture image provided by a graphics application). Image 200 may be, for example, a texture map or texture image including an array of texels having known texel values (e.g., color values). Image 200 may be, for example, a texture map (e.g., a UV texture map) or texture image. In some examples, image 200 may be a multidimensional grid (e.g., a UV grid). According to aspects described herein, the letters “U” and “V” may denote the axes of image 200. The device 115 may identify or select target texel 225 based on, for example, a portion of a scene or object (e.g., a target object) to be rendered by the graphics application. Alternatively or additionally, the device 115 may identify or select target texel 225 on a random or semi-random basis.

Based on the texel coordinate (u,v) of target texel 225, the device 115 may determine a set of neighboring texels (e.g., neighboring texels 205 through 220) included in image 200. In an example, one or more of the neighboring texels 205 through 220 may be adjacent (e.g., directly adjacent) to the texel coordinate (u,v). For example, one or more of the neighboring texels 205 through 220 may be in contact with the texel coordinate (u,v). According to example aspects herein, target texel 225 and one or more of the neighboring texels 205 through 220 may be associated with the same scene or object (e.g., target object) in image 200.

In some examples, the neighboring texels 205 through 220 may be located immediately above, below, left, and right of the texel coordinate (u,v), respectively. In some examples, such as in an example aspect illustrated in FIG. 2, the neighboring texels 205 through 220 may be located to the upper left, lower left, upper right, and lower right of the texel coordinate (u,v), respectively. For example, neighboring texels 205 through 220 may be located at texel coordinates T(iU0, iV0) through T(iU1, iV1), respectively.

In some examples, the device 115 may determine texel values (e.g., color values) of multiple neighboring texels of the set of neighboring texels 205 through 220 and process target texel 225 based on the texel values. In an example, in processing the target texel, the device 115 may apply a filtering operation on target texel 225 using a filtering model. In some examples, the filtering operation may include texture filtering (e.g., linear texture filtering, bilinear texture filtering).

The device 115 may, in some examples, process target texel 225 using linear texture filtering, for example, based on the texel values (e.g., color values) of two or more neighboring texels of the set of neighboring texels 205 through 220. In some examples, in processing target texel 225, the device 115 may determine the texel value (e.g., color value) for target texel 225 based on an interpolation operation using a weighted average of texel values (e.g., color values) of the two or more neighboring texels of the set of neighboring texels 205 through 220. The device 115 may process target texel 225 using bilinear texture filtering, for example, based on the texel values (e.g., color values) of all four neighboring texels 205 through 220. In some examples, in processing target texel 225, the device 115 may determine the texel value (e.g., color value) for target texel 225 based on an interpolation operation using a weighted average of texel values (e.g., color values) of all four neighboring texels of the set of neighboring texels 205 through 220. In some examples, the device 115 may determine the weighted average based on one or more weighting coefficients applied to the texel values.

In some examples, the device 115 may process target texel 225 based on fractional values (e.g., fU and fV) of texel coordinate (u,v) and the texel values T00 through T11 of the set of neighboring texels 205 through 220. For example, the weighting coefficient for neighboring texel 205 located at texel coordinate (iV0, iU0) may be equal to a product of (1-fU) and (1-fV) (e.g., (1-fU)*(1-fV)). The device 115 may process target texel 225 using one or more linear interpolations (e.g., bilinear interpolation, multilinear interpolation), for example, to determine the texel value (e.g., color value) of target texel 225 at texel coordinate (u,v). In an example, the device 115 may perform linear interpolations in a first direction (e.g., U-axis) to determine texel values T0 and T1. In some examples, the device 115 may determine the texel value T0 using a linear interpolation in the first direction based on a fractional value (e.g., fractional value fU) of the texel coordinate (u,v) and texel values T00 and T10 of neighboring texels 205 and 215. In some examples, the device 115 may determine the texel value T1 using a linear interpolation in the first direction based on a fractional value fU of the texel coordinate (u,v) and texel values T01 and T11 of neighboring texels 210 and 220. In an example, the device 115 may determine the texel value T0 using the following expression T0=T00*(1-fU)+T10*fU, and may determine T1 using the following expression T1=T01*(1-fU)+T11*fU.

The device 115 may perform an additional linear interpolation to determine the texel value (e.g., color value) of target texel 225 at texel coordinate (u,v). In some examples, the device 115 may determine the texel value (e.g., color value) of target texel 225 at texel coordinate (u,v) using a linear interpolation in a second direction (e.g., V-axis) based on a fractional value (e.g., fractional value fV) of the texel coordinate (u,v) and texel values T0 and T1. In an example, the device 115 may determine the texel value of target texel 225 at texel coordinate (u,v) using the following expression T(u, v)=T0*(1-fV)+T1*fV.

In some examples, the device 115 may perform the linear interpolations beginning in any direction (e.g., beginning with either the U-axis or the V-axis, from any texel). For example, the device 115 may perform linear interpolations in the second direction (e.g., V-axis) to determine texel values T2 and T3, based on a fractional value (e.g., fractional value fV) of the texel coordinate (u,v) and texel values T00 through T11 of neighboring texels 205 through 220. In some examples, the device 115 may determine the texel value (e.g., color value) of target texel 225 at texel coordinate (u,v) using a linear interpolation in the first direction (e.g., U-axis) based on a fractional value (e.g., fractional value fU) of the texel coordinate (u,v) and texel values T2 and T3.

In some textures (e.g., texture images), neighboring texels belonging to the same object in a scene (e.g., grass, mountains, sky) may share the same texel values (e.g., color values). For example, neighboring texels 205 through 220 may have the same color value. In an example, if the device 115 performs linear interpolation (e.g., bilinear interpolation) for target texel 225 based on neighboring texels 205 through 220 having the same color value, the final interpolated color value for target texel 225 at texel coordinate (u,v) may be the same as the color value of the neighboring texels 205 through 220.

In an example, when neighboring texels 205 through 220 are the same (e.g., have the same texel value, for example, color value) and the device 115 processes target texel 225 using one or more linear interpolations (e.g., bilinear interpolation, multilinear interpolation) to determine the texel value (e.g., color value) of target texel 225 at texel coordinate (u,v), the texel values T00, T01, T10, T11, T0, T1, and T(u,v) will be the same. For example, the device 115 may determine the texel value of target texel 225 at texel coordinate (u,v) as follows: T00=T01=T10=T11, T0=T00*(1-fU)+T10*fU=T00*(1-fU)+T00*fU=T00*(1-fU+fU)=T00, T1=T00, and T(u, v)=T00.

The device 115 may bypass applying the filtering operation on target texel 225 at texel coordinate (u,v) based on a comparison of texel values (e.g., color values) of multiple neighboring texels of the set of neighboring texels 205 through 220. For example, the device 115 may bypass applying the filtering operation on target texel 225 at texel coordinate (u,v) based on determining that texel values (e.g., color values) of multiple neighboring texels of the set of neighboring texels 205 through 220 are the same. In some examples, the device 115 may determine and compare the texel values (e.g., color values) of two or more neighboring texels of the set of neighboring texels 205 through 220. In an example, if the device 115 determines the texel values (e.g., color values) of two or more neighboring texels of the set of neighboring texels 205 through 220 are the same, the device 115 may bypass one or more linear interpolation operations in processing the target texel 225.

In an example, the device 115 may determine that the texel values (e.g., color values) T00 and T10 of neighboring texels 205 and 215 are the same as each other, and that the texel values T01 and T11 of neighboring texels 210 and 220 are different (e.g., from each other). Accordingly, in some examples, the device 115 may determine texel value T0 without using a linear interpolation operation, and may determine texel value T1 using a linear interpolation operation as described herein. For example, the device 115 may set the texel value T0 to be equal to the texel values T00 and T10 of neighboring texels 205 and 215. Further, the device 115 may determine the texel value T1 as described herein, for example, using a linear interpolation in the first direction (e.g., U-axis) based on a fractional value fU of the texel coordinate (u,v) and texel values T01 and T11 of neighboring texels 210 and 220. According to example aspects herein, the device 115 may perform an additional linear interpolation to determine the texel value (e.g., color value) of target texel 225 at texel coordinate (u,v), using a linear interpolation in a second direction (e.g., V-axis) based on a fractional value (e.g., fractional value fV) of the texel coordinate (u,v) and texel values T0 and T1. In another example, if the device 115 determines the texel values (e.g., color values) of all four neighboring texels of the set of neighboring texels 205 through 220 are the same, the device 115 may bypass two or more linear interpolation operations (e.g., bypass using bilinear texture filtering) in processing the target texel 225.

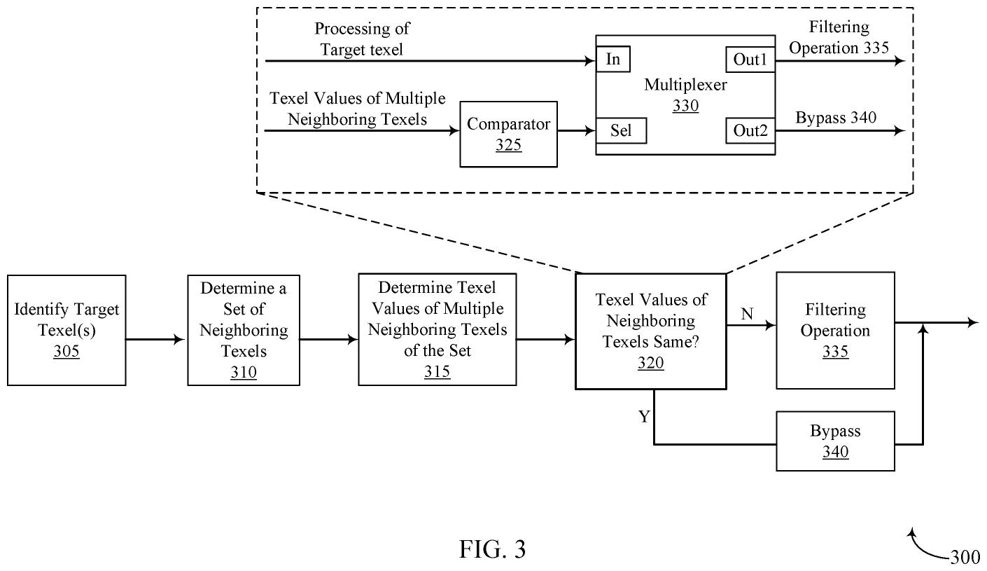

In an example, the device 115 may determine that the texel values (e.g., color values) T00 through T11 of neighboring texels 205 through 220 are the same. Accordingly, in some examples, the device 115 may determine texel value T(u,v) without using any linear interpolation operations. In an example, the device 115 may set the texel values of T0, T1, and T(u,v) to be equal to the texel values of neighboring texels 205 through 220. In an example, the device 115 may set the texel value T(u,v) to be equal to the texel values of neighboring texels 205 through 220, without setting the texel values T0 and T1. Example of texture filtering for texture data is further described in more detail herein with reference to FIG. 3.

FIG. 3 illustrates an example of a process flow 300 that supports texture filtering for texture data in accordance with aspects of the present disclosure. Process flow 300 may implement aspects of the system 100. Process flow 300 may be implemented, for example, by the device 115. In some examples, process flow 300 may be implemented by graphics processor 140 of the device 115.

At 305, the device 115 may identify a target texel having a texel coordinate in an image. For example, the device 115 may identify target texel 225 having a texel coordinate (u,v) in image 200 (e.g., a texture coordinate in an input texture image or texture map provided by a graphics application). The device 115 may identify or select target texel 225 based on, for example, a portion of a scene or object to be rendered by a graphics application associated with the device 115. Alternatively or additionally, the device 115 may identify or select target texel 225 on a random or semi-random basis. In some examples, the device 115 may identify or select two or more target texels 225 and may process the target texels 225 jointly or separately.

At 310, the device 115 may determine a set of neighboring texels 205 through 220 based on the texel coordinate (u,v) of target texel 225. In an example, neighboring texels 205 through 220 may be located at texel coordinates T(iU0, iV0) through T(iU1, iV1), respectively. In an example, one or more of the neighboring texels 205 through 220 may be adjacent (e.g., directly adjacent) to the texel coordinate (u,v). For example, one or more of the neighboring texels 205 through 220 may be in contact with the texel coordinate (u,v). In some examples, the neighboring texels 205 through 220 may be immediately above, below, left, and right of the texel coordinate, respectively. In some examples, the neighboring texels 205 through 220 may be located to the upper left, lower left, upper right, and lower right of the texel coordinate (u,v), respectively. According to example aspects herein, the device 115 may determine the set of neighboring texels 205 through 220 based on the scene or object (e.g., target object) associated with identifying the target texel 225.

At 315, the device 115 may determine texel values (e.g., color values) of multiple neighboring texels of the set of neighboring texels 205 through 220. In an example, device 115 may determine color values of two or more neighboring texels of the set of neighboring texels 205 through 220. In an example, device 115 may determine color values of all four neighboring texels of the set of neighboring texels 205 through 220. In some examples, a color value may be related to an RGB color model. That is, a color value may correspond to a color value in an RGB color model.

At 320, the device 115 may compare the texel values (e.g., color values) of the multiple neighboring texels of the set of neighboring texels 205 through 220, for example, to determine whether the multiple neighboring texels have the same color value. In an example, the device 115 may compare the color values of two neighboring texels of the set of neighboring texels 205 through 220, for example, to determine whether the two neighboring texels have the same color value. In an example, the device 115 may compare the color values of all four neighboring texels of the set of neighboring texels 205 through 220, for example, to determine whether all four neighboring texels have the same color value. According to example aspects described herein, the device 115 may process target texel 225 based on the comparison. For example, at 320, the device 115 may determine whether to process target texel 225 using a filtering operation 335 or to bypass the filtering operation 335.

According to aspects described herein, the device 115 may perform filtering operation 335 on target texel 225, for example, via a filtering engine, based on determining that the multiple neighboring texels have different color values. In an example, the filtering operation 335 may include applying a weighted color value to the target texel. In some examples, the device 115 may determine the weighted color value based on a weighting coefficient. For example, the device 115 may perform an interpolation operation on the multiple neighboring texels of the set of neighboring texels 205 through 220. In an example, the device 115 may determine a sum color value of the color values of the multiple neighboring texels of the set of neighboring texels 205 through 220 based on the interpolation operation. According to example aspects herein, the sum color value may be a weighted sum color value. In an example, the device 115 may multiply a weighting coefficient as described herein by the color values of the multiple neighboring texels of the set of neighboring texels 205 through 220 and determine a weighted sum color value from the weighted color values.

Additionally or alternatively, at 340, the device 115 may bypass performing the filtering operation 335 on the target texel based on determining that the multiple neighboring texels have the same color values. In some examples, the device 115 may bypass the filtering operation 335 (e.g., bypassing a filtering engine). In some examples, the device may bypass one or more portions of the filtering operation 335 (e.g., bypass one or more linear interpolation operations in processing the target texel 225). Bypassing the filtering operation 335 may include, for example, maintaining a color value of the target texel. In some examples, bypassing the filtering operation 335 may include determining a color value of point between at least two neighboring texels, without using a linear interpolation operation (e.g., setting a texel value T0 to be equal to the texel values T00 and T10 of neighboring texels 205 and 215, where texel values T00 and T10 are the same).

In some examples, the device 115 may bypass filtering operations for one or more of the multiple neighboring texels of the set of neighboring texels 205 through 220 based on bypassing the filtering operation 335 on the target texel 225. In some examples, the device 115 may process a neighboring texel of the set of neighboring texels 205 through 220 according to the example aspects described herein. For example, the device 115 may process the neighboring texel according to example aspects of process flow 300. In an example, the device 115 may process the neighboring texel based on a filtering operation (e.g., filtering operation 355), or bypass the filtering operation (e.g., maintain a color value of the neighboring texel) based on bypassing the filtering operation 355 on target texel 225.

The device 115 may, in some examples, include a comparator 325 and a multiplexer 330. Comparator 325 and multiplexer 330 may be implemented, for example, as hardware, software, or both. In an example, comparator 325 may compare the color values of the multiple neighboring texels of the set of neighboring texels 205 through 220. In an example, the device 115 may bypass the filtering operation 335 via the multiplexer 330, based on one or more comparisons by the comparator 325. For example, the device 115 may compare the color values using the comparator 325 and bypass the filtering operation 335 via multiplexer 330.

Particular aspects of the subject matter described herein may be implemented to realize one or more advantages. The described methods, systems, devices, and apparatuses provide graphics processing techniques which may support bypassing a filtering engine in a processing pipeline of a GPU, reducing GPU overhead and processing time, among other advantages. As such, supported techniques may include features for enhancing user experience through improved processing efficiency and bandwidth. For example, where a large portion of neighboring texels (e.g., four texels) of the target texel are identical (e.g., same color values), bypassing a filtering operation (e.g., bypassing the filtering engine, maintaining a color value of the target texel) when processing the target texel may reduce power consumption, improve GPU performance (e.g., filtering performance), or both. For example, the device 115 may use multiple cycles to perform a filtering operation (e.g., bilinear filtering operation) in the case of a filtering mode, for example, when processing a target texel. In an example where neighboring texels of the target texel are identical (e.g., same color values), the device 115 may process the target texel in one cycle, which may lead to performance improvement (e.g., saving dynamic power of the filter engine present inside GPU 140). Aspects described herein may also lead to performance improvement in some cases of bilinear filtering (e.g., fp32 bilinear filtering).

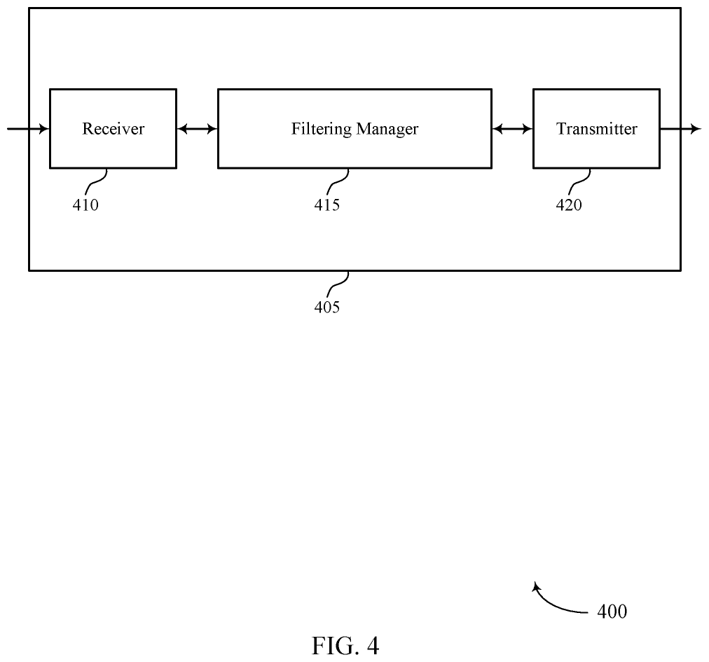

FIG. 4 shows a block diagram 400 of a device 405 that supports texture filtering for texture data in accordance with aspects of the present disclosure. The device 405 may be an example of aspects of a device as described herein. The device 405 may include a receiver 410, a filtering manager 415, and a transmitter 420. The device 405 may also include a processor. Each of these components may be in communication with one another (e.g., via one or more buses).

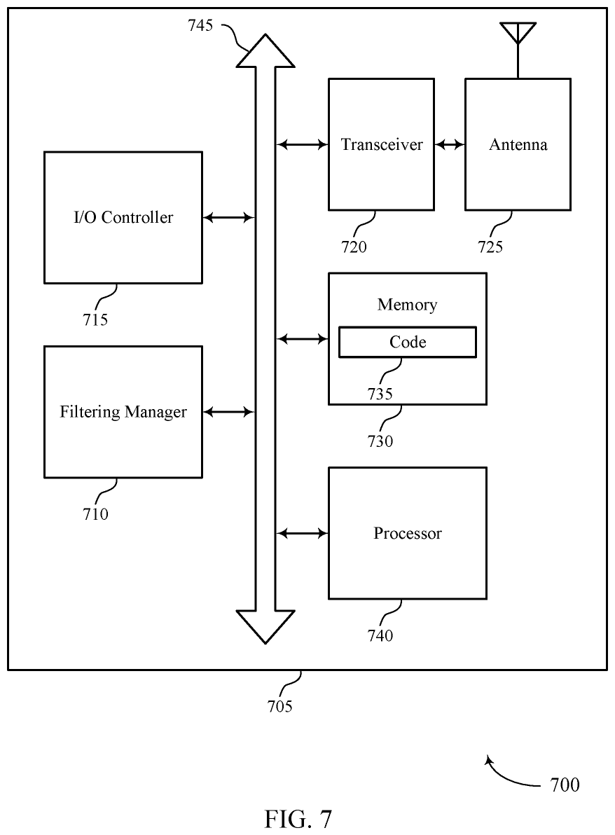

The receiver 410 may receive texel information (e.g., information related to texture filtering for texture data). Information may be passed on to other components of the device 405. The receiver 410 may be an example of aspects of the transceiver 720 described with reference to FIG. 7. The receiver 410 may utilize a single antenna or a set of antennas.

The filtering manager 415 may identify a target texel having a texel coordinate in an image, determine a set of neighboring texels based on the texel coordinate of the target texel, and determine color values of multiple neighboring texels of the set of neighboring texels. The filtering manager 415 may compare the color values of the multiple neighboring texels of the set of neighboring texels and process the target texel based on the comparing. The filtering manager 415 may be an example of aspects of the filtering manager 710 described herein.

The filtering manager 415 described herein may be implemented to realize one or more advantages. One implementation may allow the device 405 to provide graphics processing techniques supportive of bypassing a filtering engine in a processing pipeline of a GPU, which may reduce GPU overhead and processing time, among other advantages. For example, the device 405 may include features for bypassing a filtering operation on a target texel based on same texel values (e.g., color values) of neighboring texels, thus enhancing user experience through improved processing efficiency and bandwidth. For example, where a large portion of neighboring texels (e.g., four texels) of the target texel are identical (e.g., same color values), the device 405 may bypass a filtering operation (e.g., bypass the filtering engine, maintain a color value of the target texel) when processing the target texel, which may reduce power consumption, improve GPU performance (e.g., filtering performance), or both.

The filtering manager 415, or its sub-components, may be implemented in hardware, code (e.g., software or firmware) executed by a processor, or any combination thereof. If implemented in code executed by a processor, the functions of the filtering manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The filtering manager 415, or its sub-components, may be physically located at various positions, including being distributed such that portions of functions are implemented at different physical locations by one or more physical components. In some examples, the filtering manager 415, or its sub-components, may be a separate and distinct component in accordance with various aspects of the present disclosure. In some examples, the filtering manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 420 may transmit signals generated by other components of the device 405. In some examples, the transmitter 420 may be collocated with a receiver 410 in a transceiver module. For example, the transmitter 420 may be an example of aspects of the transceiver 720 described with reference to FIG. 7. The transmitter 420 may utilize a single antenna or a set of antennas.

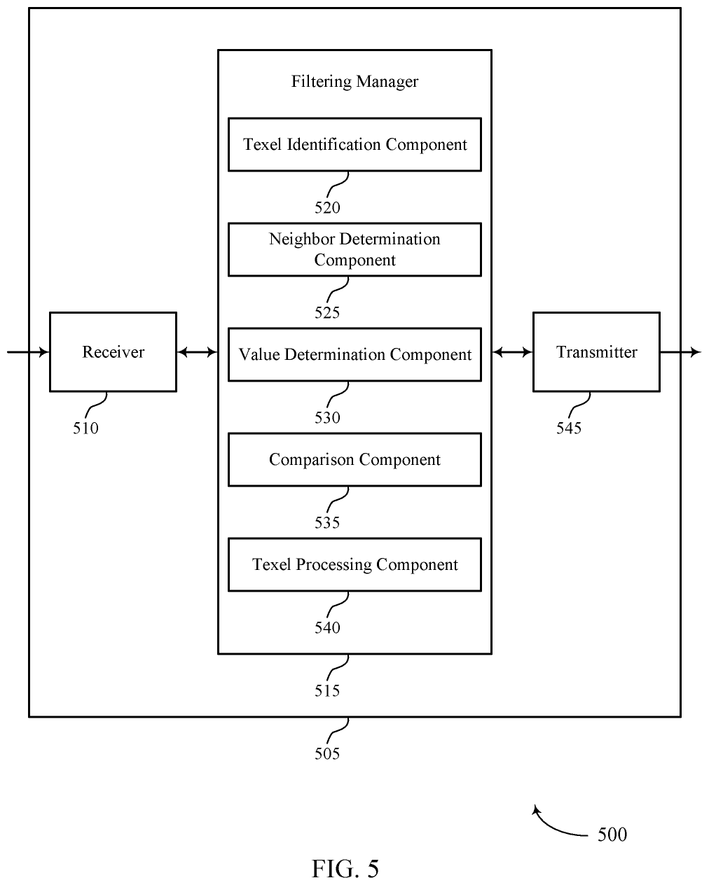

FIG. 5 shows a block diagram 500 of a device 505 that supports texture filtering for texture data in accordance with aspects of the present disclosure. The device 505 may be an example of aspects of a device 405 or a device 115 as described herein. The device 505 may include a receiver 510, a filtering manager 515, and a transmitter 545. The device 505 may also include a processor. Each of these components may be in communication with one another (e.g., via one or more buses).

The receiver 510 may receive information such as texel information (e.g., information related to texture filtering for texture data). Information may be passed on to other components of the device 505. The receiver 510 may be an example of aspects of the transceiver 720 described with reference to FIG. 7. The receiver 510 may utilize a single antenna or a set of antennas.

The filtering manager 515 may be an example of aspects of the filtering manager 415 as described herein. The filtering manager 515 may include a texel identification component 520, a neighbor determination component 525, a value determination component 530, a comparison component 535, and a texel processing component 540. The filtering manager 515 may be an example of aspects of the filtering manager 710 described herein.

The texel identification component 520 may identify a target texel having a texel coordinate in an image. The neighbor determination component 525 may determine a set of neighboring texels based on the texel coordinate of the target texel. The value determination component 530 may determine color values of multiple neighboring texels of the set of neighboring texels. The comparison component 535 may compare the color values of the multiple neighboring texels of the set of neighboring texels. The texel processing component 540 may process the target texel based on the comparing.

The transmitter 545 may transmit signals generated by other components of the device 505. In some examples, the transmitter 545 may be collocated with a receiver 510 in a transceiver module. For example, the transmitter 545 may be an example of aspects of the transceiver 720 described with reference to FIG. 7. The transmitter 545 may utilize a single antenna or a set of antennas.

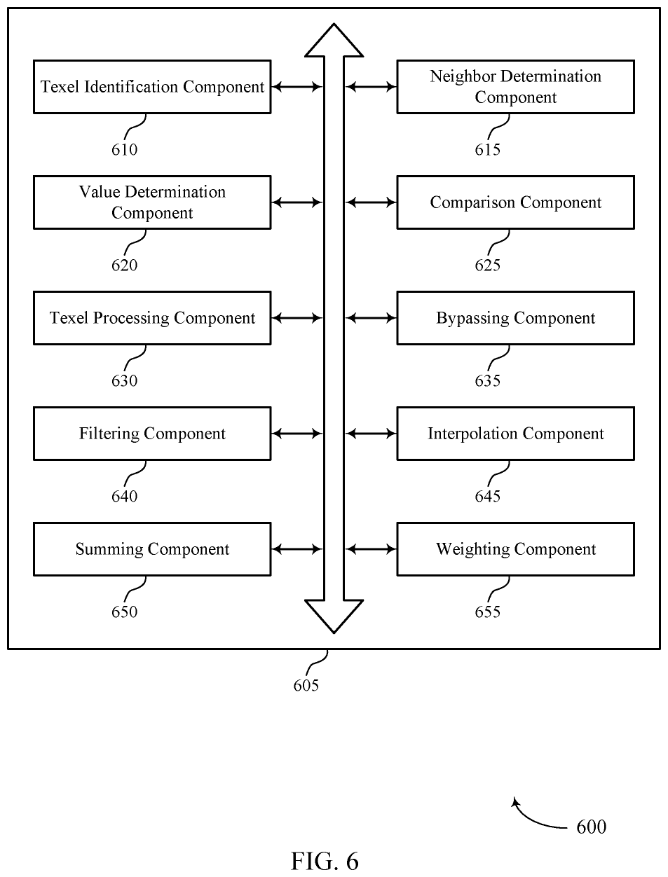

FIG. 6 shows a block diagram 600 of a filtering manager 605 that supports texture filtering for texture data in accordance with aspects of the present disclosure. The filtering manager 605 may be an example of aspects of a filtering manager 415, a filtering manager 515, or a filtering manager 710 described herein. The filtering manager 605 may include a texel identification component 610, a neighbor determination component 615, a value determination component 620, a comparison component 625, a texel processing component 630, a bypassing component 635, a filtering component 640, an interpolation component 645, a summing component 650, and a weighting component 655. Each of these modules may communicate, directly or indirectly, with one another (e.g., via one or more buses).

The texel identification component 610 may identify a target texel having a texel coordinate in an image. The neighbor determination component 615 may determine a set of neighboring texels based on the texel coordinate of the target texel. In some cases, one or more of the multiple neighboring texels of the set of neighboring texels may be positioned directly adjacent to the target texel. In some cases, the multiple neighboring texels of the set of neighboring texels may be in contact with the target texel. In some cases, the target texel and one or more of the multiple neighboring texels of the set of neighboring texels may be associated with a same target object in the image.

The value determination component 620 may determine color values of multiple neighboring texels of the set of neighboring texels. In some examples, the value determination component 620 may determine a color value of each neighboring texel of the set of neighboring texels and compare each color value of each neighboring texel of the set of neighboring texels to every other value of each neighboring texel of the set of neighboring texels. The comparison component 625 may compare the color values of the multiple neighboring texels of the set of neighboring texels. In some examples, the comparison component 625 may determine that the multiple neighboring texels have same color values. In some examples, the comparison component 625 may determine that the multiple neighboring texels have different color values.

The texel processing component 630 may process the target texel based on the comparing. The bypassing component 635 may bypass a filtering operation on the target texel based on the multiple neighboring texels having the same color values. In some examples, the bypassing component 635 may maintain a color value of the target texel. In some examples, the bypassing component 635 may bypass an additional filtering operation on one or more of the multiple neighboring texels of the set of neighboring texels based on bypassing the filtering operation on the target texel.

The filtering component 640 may perform a filtering operation on the target texel based on determining that the multiple neighboring texels have different color values. The interpolation component 645 may perform an interpolation operation on the multiple neighboring texels of the set of neighboring texels. In some examples, the image may include a multidimensional grid. and the interpolation component 645 may perform a first linear interpolation operation in a first direction of the multidimensional grid based on a fractional value of the texel coordinate. In some examples, the interpolation component 645 may perform a second linear interpolation operation in a second direction of the multidimensional grid different from the first direction based on the fractional value of the texel coordinate. In some cases, the interpolation operation may include a bilinear interpolation operation.

The summing component 650 may determine a sum color value of the color values of the multiple neighboring texels of the set of neighboring texels based on the interpolation operation. In some examples, the summing component 650 may determine the sum color value of the color values of the multiple neighboring texels of the set of neighboring texels based on a product of the first linear interpolation operation and the second linear interpolation operation. The weighting component 655 may determine a weighted color value based on a weighting coefficient, and in performing the filtering operation, the filtering component 640 may apply the weighted color value on the target texel.

FIG. 7 shows a diagram of a system 700 including a device 705 that supports texture filtering for texture data in accordance with aspects of the present disclosure. The device 705 may be an example of or include the components of device 405, device 505, or a device as described herein. The device 705 may include components for bi-directional voice and data communications including components for transmitting and receiving communications, including a filtering manager 710, an I/O controller 715, a transceiver 720, an antenna 725, memory 730, and a processor 740. These components may be in electronic communication via one or more buses (e.g., bus 745).

The filtering manager 710 as described herein may be implemented to realize one or more potential advantages. One implementation may allow the device 705 to save power and increase battery life by performing image processing operations more efficiently. For example, the device 705 may efficiently perform image processing operations by either performing a filtering operation on a pixel (also referred to as a texel) or bypassing the filtering operation on the pixel. For example, the filtering manager 710 may identify a target texel having a texel coordinate in an image, determine a set of neighboring texels based on the texel coordinate of the target texel, and determine color values of multiple neighboring texels of the set of neighboring texels. The filtering manager 710 may compare the color values of the multiple neighboring texels of the set of neighboring texels and process the target texel based on the comparing. Another implementation may promote low latency image processing operations at the device 705, such as decreased usage on GPU resources (e.g., through improved processing efficiency and bandwidth), among other advantages. As described herein, the filtering manager 710 may achieve these benefits by processing a target texel of a texture image in a processing pipeline of a GPU based on a comparison of color values of multiple neighboring texels to the target texel.

The filtering manager 710 or one or more components of the filtering manager 710 described herein may perform and/or be a means for identifying a target texel having a texel coordinate in an image. The filtering manager 710 or one or more components of the filtering manager 710 described herein may perform and/or be a means for determining a set of neighboring texels based at least in part on the texel coordinate of the target texel. The filtering manager 710 or one or more components of the filtering manager 710 described herein may perform and/or be a means for means for determining color values of multiple neighboring texels of the set of neighboring texels. The filtering manager 710 or one or more components of the filtering manager 710 described herein may perform and/or be a means for comparing the color values of the multiple neighboring texels of the set of neighboring texels. The filtering manager 710 or one or more components of the filtering manager 710 described herein may perform and/or be a means for processing the target texel based at least in part on the comparing.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS, ANDROID, MS-DOS, MS-WINDOWS, OS/2, UNIX, LINUX, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described herein. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas. In some cases, the device 705 may include a single antenna 725. However, in some cases the device 705 may have more than one antenna 725 which may be capable of concurrently transmitting or receiving multiple wireless transmissions.

The memory 730 may include RAM and ROM. The memory 730 may store computer-readable, computer-executable code 735 including instructions that, when executed, cause the processor to perform various functions described herein. In some cases, the memory 730 may contain, among other things, a Basic Input/Output System (BIOS) which may control basic hardware or software operation such as the interaction with peripheral components or devices.

The code 735 may include instructions to implement aspects of the present disclosure, including instructions to support image processing. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

The processor 740 may include an intelligent hardware device, (e.g., a general-purpose processor, a DSP, a CPU, a GPU, a microcontroller, an ASIC, an FPGA, a programmable logic device, a discrete gate or transistor logic component, a discrete hardware component, or any combination thereof). For example, the processor 740 may represent one or more dedicated GPU or CPU processors for performing graphical operations (e.g., functions or tasks supporting texture filtering for texture data). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting texture filtering for texture data).

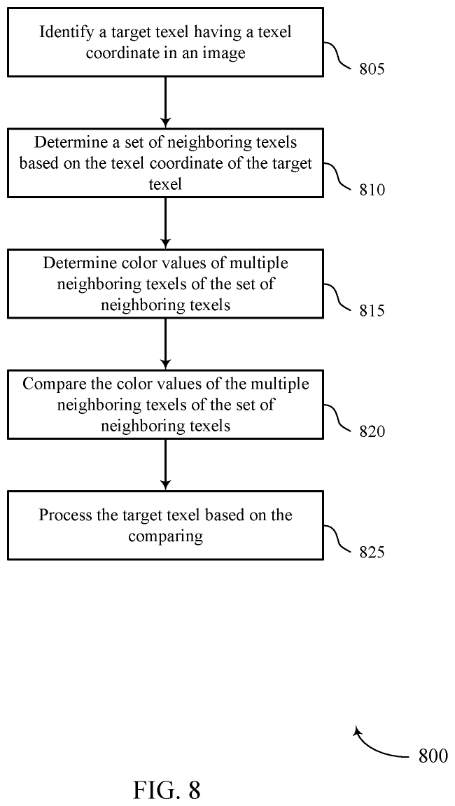

FIG. 8 shows a flowchart illustrating a method 800 that supports texture filtering for texture data in accordance with aspects of the present disclosure. The operations of method 800 may be implemented by a device or its components as described herein. For example, the operations of method 800 may be performed by a filtering manager as described with reference to FIGS. 4 through 7. In some examples, a device may execute a set of instructions to control the functional elements of the device to perform the functions described herein. Additionally or alternatively, a device may perform aspects of the functions described herein using special-purpose hardware.

At 805, the device may identify a target texel having a texel coordinate in an image. The operations of 805 may be performed according to the methods described herein. In some examples, aspects of the operations of 805 may be performed by a texel identification component as described with reference to FIGS. 4 through 7.

At 810, the device may determine a set of neighboring texels based on the texel coordinate of the target texel. The operations of 810 may be performed according to the methods described herein. In some examples, aspects of the operations of 810 may be performed by a neighbor determination component as described with reference to FIGS. 4 through 7.

At 815, the device may determine color values of multiple neighboring texels of the set of neighboring texels. The operations of 815 may be performed according to the methods described herein. In some examples, aspects of the operations of 815 may be performed by a value determination component as described with reference to FIGS. 4 through 7.

At 820, the device may compare the color values of the multiple neighboring texels of the set of neighboring texels. The operations of 820 may be performed according to the methods described herein. In some examples, aspects of the operations of 820 may be performed by a comparison component as described with reference to FIGS. 4 through 7.

At 825, the device may process the target texel based on the comparing. The operations of 825 may be performed according to the methods described herein. In some examples, aspects of the operations of 825 may be performed by a texel processing component as described with reference to FIGS. 4 through 7.

The method 800 may thus provide improvements in efficiency related to image processing, for example, such as decreased usage on GPU resources, reduced latency related to image processing (e.g., through improved processing efficiency and bandwidth), among other advantages. As described herein, the method 800 may achieve these benefits by processing a target texel of a texture image in a processing pipeline of a GPU based on a comparison of color values of multiple neighboring texels to the target texel.

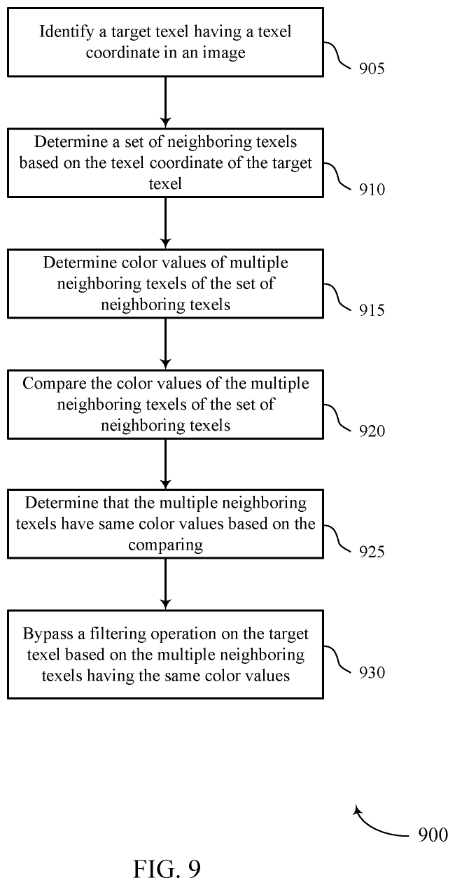

FIG. 9 shows a flowchart illustrating a method 900 that supports texture filtering for texture data in accordance with aspects of the present disclosure. The operations of method 900 may be implemented by a device or its components as described herein. For example, the operations of method 900 may be performed by a filtering manager as described with reference to FIGS. 4 through 7. In some examples, a device may execute a set of instructions to control the functional elements of the device to perform the functions described herein. Additionally or alternatively, a device may perform aspects of the functions described herein using special-purpose hardware.

At 905, the device may identify a target texel having a texel coordinate in an image. The operations of 905 may be performed according to the methods described herein. In some examples, aspects of the operations of 905 may be performed by a texel identification component as described with reference to FIGS. 4 through 7.

At 910, the device may determine a set of neighboring texels based on the texel coordinate of the target texel. The operations of 910 may be performed according to the methods described herein. In some examples, aspects of the operations of 910 may be performed by a neighbor determination component as described with reference to FIGS. 4 through 7.

At 915, the device may determine color values of multiple neighboring texels of the set of neighboring texels. The operations of 915 may be performed according to the methods described herein. In some examples, aspects of the operations of 915 may be performed by a value determination component as described with reference to FIGS. 4 through 7.

At 920, the device may compare the color values of the multiple neighboring texels of the set of neighboring texels. The operations of 920 may be performed according to the methods described herein. In some examples, aspects of the operations of 920 may be performed by a comparison component as described with reference to FIGS. 4 through 7.

At 925, the device may determine that the multiple neighboring texels have same color values based on the comparing. The operations of 925 may be performed according to the methods described herein. In some examples, aspects of the operations of 925 may be performed by a texel processing component as described with reference to FIGS. 4 through 7.

At 930, the device may bypass a filtering operation on the target texel based on the multiple neighboring texels having the same color values. The operations of 930 may be performed according to the methods described herein. In some examples, aspects of the operations of 930 may be performed by a filtering component as described with reference to FIGS. 4 through 7.

The method 900 may therefore provide improvements in efficiency related to image processing, for example, such as reduced overhead on GPU resources, decreased latency related to image processing, and enhanced user experience (e.g., through improved processing efficiency and bandwidth), among other advantages. As described herein, the method 900 may achieve these benefits by bypassing a filtering operation (e.g., a filtering engine) in a processing pipeline of a GPU.

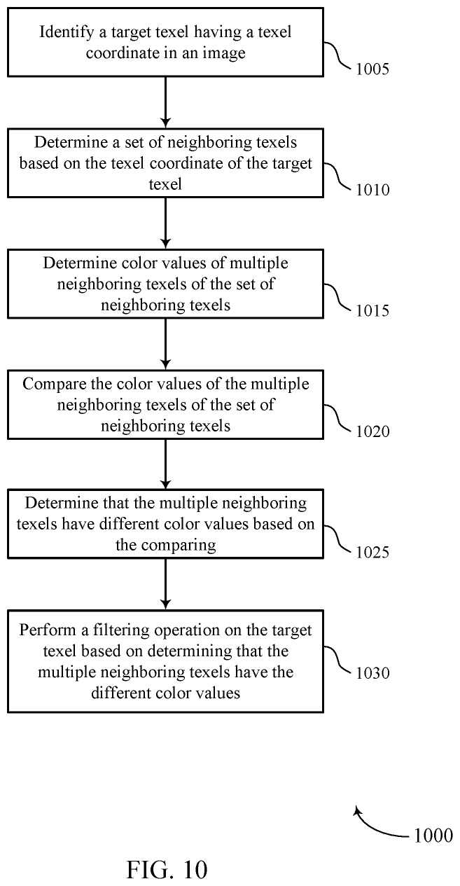

FIG. 10 shows a flowchart illustrating a method 1000 that supports texture filtering for texture data in accordance with aspects of the present disclosure. The operations of method 1000 may be implemented by a device or its components as described herein. For example, the operations of method 1000 may be performed by a filtering manager as described with reference to FIGS. 4 through 7. In some examples, a device may execute a set of instructions to control the functional elements of the device to perform the functions described herein. Additionally or alternatively, a device may perform aspects of the functions described herein using special-purpose hardware.

At 1005, the device may identify a target texel having a texel coordinate in an image. The operations of 1005 may be performed according to the methods described herein. In some examples, aspects of the operations of 1005 may be performed by a texel identification component as described with reference to FIGS. 4 through 7.

At 1010, the device may determine a set of neighboring texels based on the texel coordinate of the target texel. The operations of 1010 may be performed according to the methods described herein. In some examples, aspects of the operations of 1010 may be performed by a neighbor determination component as described with reference to FIGS. 4 through 7.

At 1015, the device may determine color values of multiple neighboring texels of the set of neighboring texels. The operations of 1015 may be performed according to the methods described herein. In some examples, aspects of the operations of 1015 may be performed by a value determination component as described with reference to FIGS. 4 through 7.

At 1020, the device may compare the color values of the multiple neighboring texels of the set of neighboring texels. The operations of 1020 may be performed according to the methods described herein. In some examples, aspects of the operations of 1020 may be performed by a comparison component as described with reference to FIGS. 4 through 7.

At 1025, the device may determine that the multiple neighboring texels have different color values based on the comparing. The operations of 1025 may be performed according to the methods described herein. In some examples, aspects of the operations of 1025 may be performed by a texel processing component as described with reference to FIGS. 4 through 7.

At 1030, the device may perform a filtering operation on the target texel based on determining that the multiple neighboring texels have the different color values. The operations of 1030 may be performed according to the methods described herein. In some examples, aspects of the operations of 1030 may be performed by a filtering component as described with reference to FIGS. 4 through 7.

It should be noted that the methods described herein describe possible implementations, and that the operations and the steps may be rearranged or otherwise modified and that other implementations are possible. Further, aspects from two or more of the methods may be combined.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for image processing, comprising:
identifying a target texel having a texel coordinate in an image;
determining a set of neighboring texels based at least in part on the texel coordinate of the target texel;
determining color values of multiple neighboring texels of the set of neighboring texels;
comparing the color values of the multiple neighboring texels of the set of neighboring texels; and
processing the target texel based at least in part on the comparing.

2. The method of claim 1, wherein processing the target texel comprises:
determining that the multiple neighboring texels have same color values based at least in part on the comparing; and
bypassing a filtering operation on the target texel based at least in part on the multiple neighboring texels having the same color values.

3. The method of claim 2, wherein bypassing the filtering operation on the target texel comprises:
maintaining a color value of the target texel.

4. The method of claim 2, further comprising:
bypassing an additional filtering operation on one or more of the multiple neighboring texels of the set of neighboring texels based at least in part on bypassing the filtering operation on the target texel.

5. The method of claim 1, wherein processing the target texel comprises:
determining that the multiple neighboring texels have different color values based at least in part on the comparing; and
performing a filtering operation on the target texel based at least in part on determining that the multiple neighboring texels have the different color values.

6. The method of claim 5, further comprising:
performing an interpolation operation on the multiple neighboring texels of the set of neighboring texels;
determining a sum color value of the color values of the multiple neighboring texels of the set of neighboring texels based at least in part on the interpolation operation; and
determining a weighted color value based at least in part on a weighting coefficient, wherein performing the filtering operation on the target texel comprises applying the weighted color value to the target texel.

7. The method of claim 6, wherein the interpolation operation comprises a bilinear interpolation operation.

8. The method of claim 6, wherein the image comprises a multidimensional grid.

9. The method of claim 8, further comprising:
performing a first linear interpolation operation in a first direction of the multidimensional grid based at least in part on a fractional value of the texel coordinate; and
performing a second linear interpolation operation in a second direction of the multidimensional grid different from the first direction based at least in part on the fractional value of the texel coordinate,
wherein determining the sum color value of the color values of the multiple neighboring texels of the set of neighboring texels is based at least in part on a product of the first linear interpolation operation and the second linear interpolation operation.

10. The method of claim 1, wherein determining the color values of the multiple neighboring texels of the set of neighboring texels comprises:
determining a color value of each neighboring texel of the set of neighboring texels, wherein comparing the color values of the multiple neighboring texels of the set of neighboring texels comprises comparing each color value of each neighboring texel of the set of neighboring texels to every other value of each neighboring texel of the set of neighboring texels.

11. The method of claim 1, wherein one or more of the multiple neighboring texels of the set of neighboring texels are positioned directly adjacent to the target texel.

12. The method of claim 1, wherein the multiple neighboring texels of the set of neighboring texels are in contact with the target texel.

13. The method of claim 1, wherein the target texel and one or more of the multiple neighboring texels of the set of neighboring texels are associated with a same target object in the image.

14. An apparatus for image processing, comprising:
a processor,
memory coupled with the processor; and
instructions stored in the memory and executable by the processor to cause the apparatus to:
identify a target texel having a texel coordinate in an image;
determine a set of neighboring texels based at least in part on the texel coordinate of the target texel;
determine color values of multiple neighboring texels of the set of neighboring texels;
compare the color values of the multiple neighboring texels of the set of neighboring texels; and
process the target texel based at least in part on the comparing.

15. The apparatus of claim 14, wherein the instructions to process the target texel are executable by the processor to cause the apparatus to:
determine that the multiple neighboring texels have same color values based at least in part on the comparing; and
bypass a filtering operation on the target texel based at least in part on the multiple neighboring texels having the same color values.

16. The apparatus of claim 15, wherein the instructions to bypass the filtering operation on the target texel are executable by the processor to cause the apparatus to:
maintain a color value of the target texel.

17. The apparatus of claim 14, wherein the instructions to process the target texel are executable by the processor to cause the apparatus to:
determine that the multiple neighboring texels have different color values based at least in part on the comparing; and
perform a filtering operation on the target texel based at least in part on determining that the multiple neighboring texels have the different color values.

18. The apparatus of claim 17, wherein the instructions are further executable by the processor to cause the apparatus to:
perform an interpolation operation on the multiple neighboring texels of the set of neighboring texels;
determine a sum color value of the color values of the multiple neighboring texels of the set of neighboring texels based at least in part on the interpolation operation; and
determine a weighted color value based at least in part on a weighting coefficient,
wherein the instructions to perform the filtering operation on the target texel are executable by the processor to cause the apparatus to apply the weighted color value to the target texel.

19. The apparatus of claim 18, wherein the interpolation operation comprises a bilinear interpolation operation.

20. An apparatus for image processing, comprising:
means for identifying a target texel having a texel coordinate in an image;
means for determining a set of neighboring texels based at least in part on the texel coordinate of the target texel;
means for determining color values of multiple neighboring texels of the set of neighboring texels;
means for comparing the color values of the multiple neighboring texels of the set of neighboring texels; and
means for processing the target texel based at least in part on the comparing.
